(19) United States
(12) Patent Application Publication
(10) Pub. No.: US 2026/0138620 A1
(43) Pub. Date: May 21, 2026

(54) METHOD AND APPARATUS FOR PROCESSING DATA OF VEHICLE

(71) Applicants: Hyundai Motor Company, Seoul (KR); Kia Corporation, Seoul (KR)

(72) Inventor: Jae Hyun Jo, Hwaseong (KR)

(21) Appl. No.: 19/241,008

(22) Filed: Jun. 17, 2025

(30) Foreign Application Priority Data
Nov. 19, 2024 (KR) 10-2024-0165597

(51) Int. Cl. B60W 50/00; G06N 20/00

(52) U.S. Cl. CPC B60W 50/00; G06N 20/00; B60W 2756/10

(57) ABSTRACT

A method of processing data of a vehicle includes preprocessing data collected while the vehicle is driving based on an abnormal data list. When abnormal data is detected among the preprocessed data, and when the abnormal data is determined to be new, the abnormal data is added to the abnormal data list. Thereafter, the abnormal data is removed from the preprocessed data, and normal data is collated by removing the abnormal data such that the normal data is transmitted to a server.

### CROSS REFERENCE TO RELATED APPLICATION

The present application claims under 35 U.S.C. § 119(a) the benefit of Korean Patent Application No. 10-2024-0165597 filed on Nov. 19, 2024, the entire contents of which are incorporated by reference herein.

### BACKGROUND

### (a) Technical Field

The present disclosure relates to a method and apparatus for processing data of a vehicle, more particularly, to a method and apparatus for preprocessing data collected from a vehicle and removing abnormal data.

### (b) Description of the Related Art

Vehicle big data is a field that includes data analysis and processing technologies and is related to real-time data detection, analysis and preprocessing, deriving customer insights, and data-based decision-making methods. Data of a vehicle is transmitted to a server and stored after driving is completed, and the server performs a preprocessing process to convert the data into a format suitable for analysis. Here, raw data is directly stored in the server.

However, as the quantity of data increases, server storage costs increase, and data may be omitted or an error may occur during processing. In addition, when the raw data is used directly without being preprocessed, the analysis result may include abnormal or incomplete data so that it is difficult to derive a reliable insight.

In addition, although the server converts data into a form suitable for analysis, since a large quantity of data that is not preprocessed is used, data storage costs increase and there is a probability in that data may be omitted or an error may occur during the processing.

Accordingly, in this technical field, there is a demand for a technology that can remove abnormal or incomplete data through data preprocessing.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure relates to removing abnormal data from various types of raw data collected within a vehicle in advance using a deep learning-based algorithm.

The present disclosure is also intended to improve accuracy of analysis using reliable refined data.

The present disclosure is also intended to improve data analysis quality and reduce data transmission costs and data storage costs by removing unnecessary and abnormal data.

The present disclosure is also intended to use a deep learning model to distinguish normal/abnormal patterns of vehicle data and to efficiently remove only abnormal data, thereby minimizing an error influencing on the analysis.

It should be noted that objects of the present disclosure are not limited to the above-described objects, and other objects of the present disclosure will be apparent to those skilled in the art from the following descriptions.

The technical problems to be solved by the present disclosure are not limited to the above-mentioned technical problems and other technical problems which are not mentioned can be clearly understood by those skilled in the art to which the present disclosure pertains from the following description.

According to one aspect, there is provided a method of processing data of a vehicle, including: preprocessing, by a processor, data collected while the vehicle is driving based on an abnormal data list; when abnormal data is detected among the preprocessed data, and when the abnormal data is determined to be new, adding, by the processor, the abnormal data to the abnormal data list; removing, by the processor, the abnormal data from the preprocessed data; collating, by the processor, normal data in which the abnormal data is removed; and transmitting, by the processor, the normal data to a server.

According to another aspect, a method of processing data includes preprocessing data collected while a vehicle is driving based on an abnormal data list; when abnormal data is detected from the preprocessed data, and when the abnormal data is a new occurrence problem that has not occurred before, adding the abnormal data to the abnormal data list; removing the abnormal data from the preprocessed data; collating normal data in which the abnormal data is removed; and transmitting the normal data to a server.

In this case, the abnormal data may be detected by applying an artificial intelligence learning model.

In this case, the collating of the normal data may include updating the artificial intelligence learning model through learning.

In this case, the artificial intelligence learning model may be an isolation forest model.

In this case, the preprocessing may be performed by performing an automation script.

In this case, the preprocessing may include a process of cleansing data based on an abnormal data list.

In this case, the abnormal data may include data having a value of FFFF, NULL, and NaN, or a minus value, over-collected data, and mis-collected data.

According to a further aspect, there is provided an apparatus for processing data, which includes a processor configured to pre-process data collected during driving based on an abnormal data list, and when abnormal data is detected from the preprocessed data and when the abnormal data is a new occurrence problem that has not occurred before, add the abnormal data to the abnormal data list, remove the abnormal data from the preprocessed data, and collate normal data in which the abnormal data is removed; and a transceiver configured to acquire the data collected while the vehicle is driving and transmit the normal data to a server.

In this case, the processor may detect the abnormal data by applying an artificial intelligence learning model.

In this case, the processor may update the artificial intelligence learning model through learning.

In this case, the artificial intelligence learning model may be an isolation forest model.

In this case, the processor may preprocess the data by performing an automation script.

In this case, the processor may perform a process of cleansing data based on an abnormal data list upon the preprocessing.

In this case, the abnormal data may include data having a value of FFFF, NULL, and NaN, or a minus value, over-collected data, and mis-collected data.

According to an additional aspect, there is provided a vehicle including: a processor configured to pre-process data collected during driving of the vehicle based on an abnormal data list, and when abnormal data is detected among the preprocessed data and when the abnormal data is determined to be new, add the abnormal data to the abnormal data list, remove the abnormal data from the preprocessed data, and collate normal data in which the abnormal data is removed; and a transceiver configured to acquire the data collected while the vehicle is driving and transmit the normal data to a server.

In this case, the processor may detect the abnormal data by applying an artificial intelligence learning model.

In this case, the processor may update the artificial intelligence learning model through learning.

In this case, the transceiver may receive data from the server, which is an external device or an external server.

### BRIEF DESCRIPTION OF THE DRAWINGS

The accompanying drawings are intended to aid understanding of embodiments of the present disclosure and provide embodiments along with detailed descriptions. However, the technical features of these embodiments are not limited to specific drawings, and the features disclosed in each drawing may be combined to form a new embodiment, in which:

FIG. 1 is a diagram illustrating a general process of analyzing data for a vehicle;

FIG. 2 is a flowchart illustrating an operation sequence of a method of processing data according to one embodiment of the present disclosure; and

FIG. 3 is a block diagram illustrating an apparatus for processing data according to one embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Specific structural and functional descriptions of the embodiments of the present disclosure disclosed in this disclosure or application are illustrative only for the purpose of describing the embodiments, and the embodiments according to the present disclosure may be implemented in various forms and should not be construed as being limited to embodiments described in the present specification or application.

The embodiments according to the present disclosure may be variously modified and may have various forms, so that specific embodiments will be illustrated in the drawings and be described in detail in the present specification or application. It should be understood, however, that it is not intended to limit the embodiments according to the concept of the present disclosure to specific disclosure forms, but it includes all modifications, equivalents, and alternatives falling within the spirit and scope of the present disclosure.

Unless defined otherwise, all terms including technical or scientific terms used herein have the same meaning as commonly understood by those skilled in the art to which the present disclosure pertains. General terms that are defined in a dictionary shall be construed to have meanings that are consistent in the context of the relevant art and will not be interpreted as having an idealistic or excessively formalistic meaning unless clearly defined in the present specification.

Hereinafter, embodiments disclosed in the present specification will be described in detail with reference to the drawings. The same reference numerals are given to the same or similar components regardless of reference numerals, and a repetitive description thereof will be omitted.

In the description of the following embodiments, the term “preset” means that a value of a parameter is predetermined when using the parameter in a process or algorithm. Depending on the embodiment, the value of the parameter may be set when a process or algorithm starts or may be set during a section in which the process or algorithm is performed.

As used in the following description, suffixes “module” and “part” for a component are used or interchangeably used solely for ease of preparation of the specification, and do not have different meanings and each of them does not function by itself.

In describing embodiments disclosed in the present specification, when a detailed description of a known related art is determined to obscure the gist of the present specification, the detailed description thereof will be omitted herein. In addition, the accompanying drawings are merely for easy understanding of the embodiments disclosed in the present specification, the technical spirit disclosed in the present specification is not limited by the accompanying drawings, and it should be understood to include all modifications, equivalents, and substitutes included in the spirit and scope of the present disclosure.

Terms including ordinal numbers such as first, second, and the like used herein may be used to describe various components, but the various components are not limited by these terms. The terms are used only for the purpose of distinguishing one component from another component.

When a component is referred to as being “connected” or “coupled” to another component, the component may be directly connected or coupled to another component, but it should be understood that still another component may be present between the component and another component. On the contrary, when a component is referred to as being “directly connected,” or “directly coupled” to another component, it should be understood that still another component may not be present between the component and another component.

Unless the context clearly dictates otherwise, the singular form includes the plural form.

In the present specification, the terms “comprising,” “having,” or the like are used to specify that a feature, a number, a step, an operation, a component, an element, or a combination thereof described herein exists, and they do not preclude the presence or addition of one or more other features, numbers, steps, operations, components, elements, or combinations thereof.

In addition, a unit or a control unit included in the names of a motor control unit (MCU), a hybrid control unit (HCU), and the like is a term widely used in the naming of a control device that controls a specific vehicle function and does not refer to a generic function unit.

For example, a controller may include a communication device for communicating with other control units or sensors to control a responsible function, a memory for storing an operating system, a logic command, and input/output information, and one or more processors for performing determination, calculation, and decision which are necessary for controlling the responsible function.

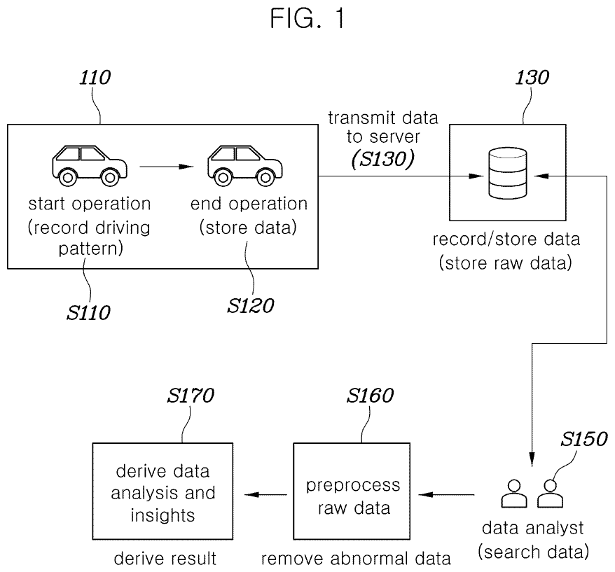

FIG. 1 is a diagram illustrating a general process of analyzing data for a vehicle.

Referring to FIG. 1, a vehicle 110 records a driving pattern from the start of operation to the end of operation (S110), and when the operation is terminated, the vehicle 110 stores data in a storage device such as a memory in the vehicle 110 (S120).

In this case, the data stored in the storage device such as the memory in the vehicle 110 may be transmitted to a server 130 for recording and storage (S130).

In this case, the data transmitted to the server 130 and recorded and stored therein is raw data and may be searched by a data analyst (S150), and may undergo a preprocessing process to remove abnormal data (S160), may derive data analysis and insights (S170).

Here, the data preprocessing of operation S160 may be a process of preparing data before the data analysis and may include a process of removing abnormal data.

When abnormal data is mixed in the raw data, since the data analysis is impossible and errors are more likely to occur, the data preprocessing process is necessary.

In this case, the abnormal data may include NULL, over-collected data, mis-collected data, and lost data.

In this case, the raw data stored in the server is accumulated and a large quantity of data is piled up. As the large quantity of data increases, the server storage cost increases and data may be omitted or errors may occur during the processing.

In addition, when the raw data is used directly without being preprocessed, the analysis result may include abnormal or incomplete data so that it is difficult to derive a reliable insight.

Hereinafter, the method of processing data of a vehicle, which can reduce a burden on the server by removing abnormal data in advance from data collected from the vehicle and improve reliability of the data will be described.

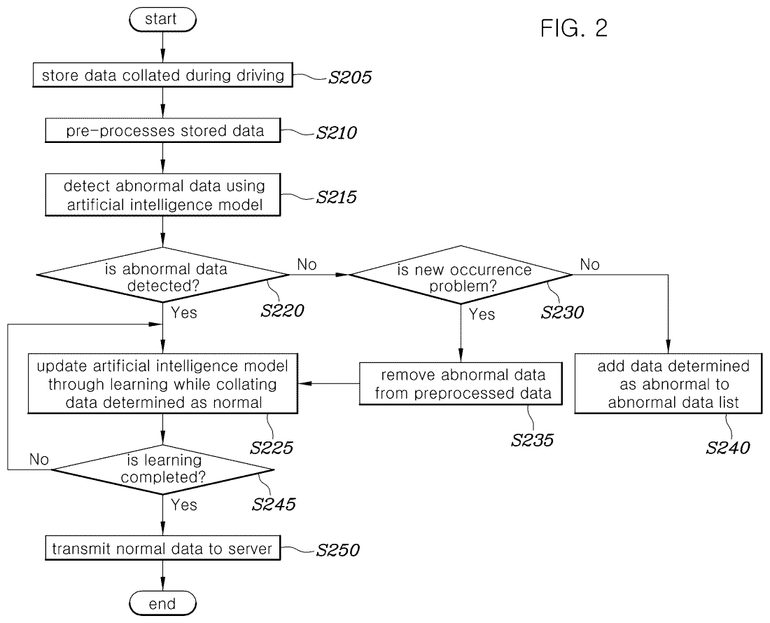

FIG. 2 is a flowchart illustrating an operation sequence of a method of processing data according to one embodiment of the present disclosure.

The method of processing data according to the present embodiment may be performed by the vehicle 110.

Referring to FIG. 2, the vehicle 110 may store data collected during driving, i.e., from the start of driving to the end of driving (S205).

In this case, the data collected during the driving may be collected by at least one sensor (not shown).

In this case, the data collected during the driving may include a driving pattern of the vehicle 110.

In this case, the collected data may be stored in a storage device such as a memory.

In addition, the vehicle 110 may pre-process the data stored in operation S205 (S210).

In this case, the vehicle 110 may pre-process the data by performing an automation script.

In this case, the data preprocessing may include a process of cleansing data based on an abnormal data list.

In this case, the abnormal data may include data having a value of FFFF, NULL, and NaN, or a minus value, over-collected data, and mis-collected data.

In addition, the vehicle 110 may detect abnormal data by applying an artificial intelligence learning model to the preprocessed data (S215) and determine whether the abnormal data is detected (S220).

In this case, the vehicle 110 may determine whether individual data included in the preprocessed data is the abnormal data.

In this case, the applied artificial intelligence learning model may be an isolation forest model. The isolation forest model is an algorithm specialized in detecting abnormal data and has an advantage of being able to quickly detect abnormal data.

In this case, the isolation forest model may perform learning in a way that, after a normal data distribution is learned, detects data that is compared with other data and is significantly different therefrom as abnormal data, and evaluates model performance by including the data after the learning to enhance accuracy.

As the determination result in operation S220, when the data included in the preprocessed data is normal data, the vehicle 110 may update the artificial intelligence model through the learning while collating the data determined as normal (S225).

Meanwhile, as the determination result in step S220, when the data included in the preprocessed data is not the normal data, the vehicle 110 may determine whether a problem occurring in the data determined as abnormal is a new problem that has not occurred before (S230), and when the problem occurring in the data determined as abnormal is not a new problem, the abnormal data is removed from the preprocessed data (S235), and the artificial intelligence model may be updated through the learning while collating the data determined as normal (S225).

In this case, the artificial intelligence model being updated may be an artificial intelligence model for detecting the abnormal data in operation S215.

As the determination result in operation S235, when the problem occurring in the data determined as abnormal is determined to be new (i.e., a newly occurring problem), the vehicle 110 may add the data determined as abnormal to an abnormal data list (S240), remove the abnormal data from the preprocessed data (S235), collate normal data from which the abnormal data is removed, and update the artificial intelligence model through the learning (S225).

Meanwhile, the vehicle 110 may determine whether the learning is completed (S245), and when the learning is completed, the vehicle 110 may transmit the normal data to the server 130 (S250), and when the learning is not completed, the vehicle 110 may repeat operation S225 until the learning is completed.

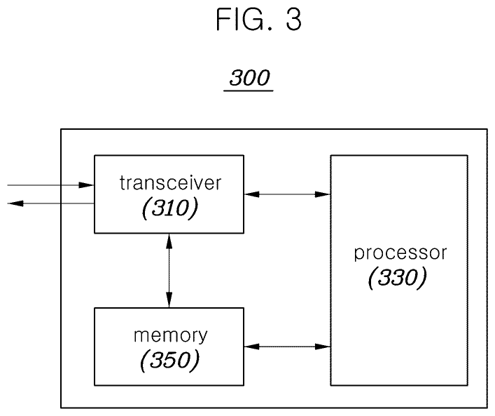

FIG. 3 is a block diagram illustrating an apparatus for processing data according to one embodiment of the present disclosure.

Referring to FIG. 3, an embodiment of the present disclosure may be implemented in a computer system such as a computer-readable recording medium. As shown in FIG. 3, an apparatus 300 for processing data may include a transceiver 310, a processor 330, and a memory 350.

The transceiver 310 may be connected to the processor 330 and transmit and/or receive information necessary for the data processing. For example, the transceiver 310 may receive data collected by the vehicle from an external device or an external server and transmits normal data in which abnormal data is removed to the external device or the external server.

In this case, the data collected by the vehicle may be collected by at least one sensor (not shown).

The processor 330 may include an application-specific integrated circuit (ASIC), other chip-sets, logic circuits, and/or a data processing apparatus. The processor 330 may implement the method of processing data proposed in the present specification. Specifically, the processor 330 may implement all operations of the method of processing data described in the embodiment disclosed herein and performs the all operations of the method of processing data according to FIG. 1.

For example, the processor 330 may store data collected from the start of driving to the end of driving, that is, during the driving, in the memory 350.

In this case, the data collected during the driving may include a driving pattern of the vehicle 110.

In addition, the processor 330 may pre-process the data stored in the memory 350.

In this case, the processor 330 may pre-process the data by performing an automation script.

In this case, the processor 330 may perform a process of cleansing data based on the abnormal data list upon the pre-processing.

In this case, the abnormal data may include data having a value of FFFF, NULL, and NaN, or a minus value, over-collected data, and mis-collected data.

In addition, the processor 330 may detect abnormal data by applying an artificial intelligence learning model to the preprocessed data and determines whether the abnormal data is detected.

In this case, the processor 330 may determine whether individual data included in the preprocessed data is the abnormal data.

In this case, the applied artificial intelligence learning model may be an isolation forest model. The isolation forest model is an algorithm specialized in detecting abnormal data and has an advantage of being able to quickly detect abnormal data.

In this case, the isolation forest model may perform learning in a way that, after a normal data distribution is learned, detects data that is compared with other data and is significantly different therefrom as abnormal data, and evaluates model performance by including the data after the learning to enhance accuracy.

In this case, when the data included in the preprocessed data is normal data, the processor 330 may update the artificial intelligence model through learning while collating data determined as normal.

Meanwhile, when the data included in the preprocessed data is not the normal data, the processor 330 may determine whether a problem occurring in the data determined as abnormal is a new problem that has not occurred before, and when the problem occurring in the data determined as abnormal is not a new problem, the processor 330 may remove the abnormal data from the preprocessed data and update the artificial intelligence model through the learning while collating the data determined as normal.

In this case, the artificial intelligence model being updated may be an artificial intelligence model for detecting abnormal data, for example, an isolation forest model.

When the problem occurring in the data determined as abnormal is a newly occurring problem, the processor 330 may add the data determined as abnormal to an abnormal data list, remove the abnormal data from the preprocessed data, collate normal data in which the abnormal data is removed, and update the artificial intelligence model through the learning.

Meanwhile, the processor 330 may determine whether the learning is completed, and when the learning is completed, the processor 330 may transmit normal data to the server, and when the learning is not completed, the processor 330 may collate normal data in which the abnormal data is removed until the learning is completed and update the artificial intelligence model through the learning.

The memory 350 may include a read-only memory (ROM), a random access memory (RAM), a flash memory, a memory card, a storage medium, and/or other storage devices. The memory 350 stores at least one of data collected while the vehicle is driving, an abnormal data list, the preprocessed data, an artificial intelligence learning model, or a combination thereof.

According to the above-described embodiments of the present disclosure, accuracy of the data analysis can be improved by learning and classifying a normal or abnormal pattern through a deep learning algorithm.

In addition, a data analysis error can be minimized and high reliability can be provided for data-based decision-making.

Additionally, transmission costs can be reduced by reducing a transmission quantity of data.

In addition, by storing only the normal data, storage resources required for data storage can be reduced, contributing to reducing data center operating costs can be achieved, and a problem that may arise during long-term data management can be reduced.

In addition, it can reduce a human error and increase data stability and reliability by quickly and accurately detecting the abnormal data in the large quantity of data.

Meanwhile, the above-described present disclosure can be implemented as computer-readable codes in a medium on which a program is recorded. The computer-readable medium includes all types of recording devices in which data readable by a computer system is stored. Examples of the computer-readable medium include hard disk drives (HDDs), solid state disks (SSDs), silicon disk drives (SDDs), read only memories (ROMs), random access memories (RAMs), compact disc ROMs (CD-ROMs), magnetic tapes, floppy disks, and optical data storage devices. Therefore, the above detailed description should not be construed as restrictive in all respects and should be considered as illustrative. The scope of the present disclosure should be determined by a reasonable interpretation of the appended claims, and all modifications within the equivalent scope of the present disclosure are included in the scope of the present disclosure.

According to the above-described various embodiments of the present disclosure, accuracy of the data analysis can be improved by learning and classifying a normal or abnormal pattern through a deep learning algorithm.

In addition, a data analysis error can be minimized and high reliability can be provided for data-based decision-making.

Additionally, transmission costs can be reduced by reducing a transmission quantity of data.

In addition, by storing only the normal data, storage resources required for data storage can be reduced, contributing to reducing data center operating costs can be achieved, and a problem that may arise during long-term data management can be reduced.

In addition, it can reduce a human error and increase data stability and reliability by quickly and accurately detecting the abnormal data in the large quantity of data.

The effects obtained by the present disclosure are not limited to the above-mentioned effects and other effects which are not mentioned can be clearly understood by those skilled in the art to which the present disclosure pertains from the above description.

Although specific embodiments of the present disclosure have been described and illustrated, those skilled in the art will appreciate that various alternations and modifications are possible without departing from the technical spirit of the present disclosure as disclosed in the appended claims.

What is claimed is:

1. A method of processing data of a vehicle, the method comprising:
preprocessing, by a processor, data collected while the vehicle is driving based on an abnormal data list;
when abnormal data is detected among the preprocessed data, and when the abnormal data is determined to be new, adding, by the processor, the abnormal data to the abnormal data list;
removing, by the processor, the abnormal data from the preprocessed data;
collating, by the processor, normal data in which the abnormal data is removed; and
transmitting, by the processor, the normal data to a server.

2. The method of claim 1, wherein the abnormal data is detected by applying an artificial intelligence learning model.

3. The method of claim 2, wherein collating the normal data includes updating the artificial intelligence learning model through learning.

4. The method of claim 2, wherein the artificial intelligence learning model is an isolation forest model.

5. The method of claim 1, wherein the preprocessing is performed by performing an automation script.

6. The method of claim 1, wherein the preprocessing includes cleansing data based on the abnormal data list.

7. The method of claim 1, wherein the abnormal data includes data having a value of FFFF, NULL, or NaN.

8. The method of claim 1, wherein the abnormal data includes a minus value, over-collected data, or mis-collected data.

9. An apparatus for processing data of a vehicle, the apparatus comprising:
a processor configured to pre-process data collected during driving of the vehicle based on an abnormal data list, and when abnormal data is detected among the preprocessed data and when the abnormal data is determined to be new, add the abnormal data to the abnormal data list, remove the abnormal data from the preprocessed data, and collate normal data in which the abnormal data is removed; and
a transceiver configured to acquire the data collected while the vehicle is driving and transmit the normal data to a server.

10. The apparatus of claim 9, wherein the processor is configured to detect the abnormal data by applying an artificial intelligence learning model.

11. The apparatus of claim 10, wherein the processor is configured to update the artificial intelligence learning model through learning.

12. The apparatus of claim 10, wherein the artificial intelligence learning model is an isolation forest model.

13. The apparatus of claim 9, wherein the processor is configured to preprocess the data by performing an automation script.

14. The apparatus of claim 9, wherein the processor is configured to perform a process of cleansing data based on the abnormal data list upon the preprocessing.

15. The apparatus of claim 9, wherein the abnormal data includes data having a value of FFFF, NULL, or NaN.

16. The apparatus of claim 9, wherein the abnormal data includes a minus value, over-collected data, or mis-collected data.

17. A vehicle comprising:
a processor configured to pre-process data collected during driving of the vehicle based on an abnormal data list, and when abnormal data is detected among the preprocessed data and when the abnormal data is determined to be new, add the abnormal data to the abnormal data list, remove the abnormal data from the preprocessed data, and collate normal data in which the abnormal data is removed; and
a transceiver configured to acquire the data collected while the vehicle is driving and transmit the normal data to a server.

18. The vehicle of claim 17, wherein the processor is configured to detect the abnormal data by applying an artificial intelligence learning model.

19. The vehicle of claim 17, wherein the processor is configured to update the artificial intelligence learning model through learning.
